(19) United States
(12) Patent Application Publication
(10) Pub. No.: US 2008/0238889 A1
(43) Pub. Date: Oct. 2, 2008

(54) Message Board with Dynamic Message Relocation

(75) Inventor: Gregory L. Thorne, Northport, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELETRONIC. N.V., EINDHOVEN (NL)

(21) Appl. No.: 10/597,330

(22) PCT Filed: Jan. 17, 2005
(86) PCT No.: PCT/IB2005/050194

§ 371 Date: Jul. 20, 2006

Related U.S. Application Data
(60) Provisional application No. 60/537,805, filed on Jan. 20, 2004.

(51) Int. Cl. G09G 5/00; G02B 27/00

(52) U.S. Cl. 345/204

(57) ABSTRACT

A display system detects a position of a viewer relative to the display device, and adjusts the presentation of information at the display device based on this relative position. The adjustment of the presentation may be to increase or decrease the intrusiveness of the displayed information. In a commercial billboard display, the presentation is adjusted to potentially increase a viewer's awareness of key terms or phrases; in a multi-purpose consumer device, such as a vanity mirror with an integral display, the presentation is adjusted to minimize the intrusion of the information relative to the primary purpose of the device.

This invention relates to the field of display systems, and in particular to a display system for displaying messages at varying locations, dependent upon a relative location of a viewer of the messages.

Electronic messaging systems are becoming increasingly popular, ranging from personal message boards to commercial billboards. Large screen commercial advertisement displays are common in public areas, such as airports and convention centers, and smaller display systems are being incorporated into consumer devices.

U.S. Pat. No. 6,560,027, “SYSTEM AND METHOD FOR DISPLAYING INFORMATION ON A MIRROR”, issued 6 May 2003 to Robert K. Meine, teaches a vanity mirror that is configured to display images from a computer system through the mirror, and is incorporated by reference herein. A display device is located behind a transmissive region of the vanity mirror. When the display device is activated, video images from the computer are displayed in the vanity mirror in this transmissive region; when the display is not activated, this transmissive region appears reflective. In the example embodiment, the display device presents news items, e-mail, and a calendar of appointments for the user to view while performing personal hygiene procedures.

U.S. patent application 2002/0196333, “MIRROR AND IMAGE DISPLAY SYSTEM”, filed 21 Jun. 2001 for Ignaz M. Gorischeck, and incorporated by reference herein, also teaches a mirror-display system, wherein the video images that are displayed are provided from devices such as VCRs, video and digital cameras, DVD players, and so on.

In each of the above systems, the information provided by the video display appears at a relatively fixed location. Although the information may change, and perhaps scroll down the display area, the display region remains relatively constant. In a commercial billboard display, the display region is selected based on a generic model of a typical viewer of the display. In the above referenced patent and patent application, the display region corresponds to the transmissive region of the mirror at which the display is located.

It is an object of this invention to provide a display system that presents information for display based on a relative location of a viewer of the information. It is a further object of this invention to provide a display system that dynamically adjusts a display of information based on a relative location of a viewer of the information.

These objects, and others, are achieved by a display system that detects a position of a viewer relative to the display device, and adjusts the presentation of information at the display device based on this relative position. The adjustment of the presentation may be to increase or decrease the intrusiveness of the displayed information as well as to adjust the positioning of portions of the presentation. In a commercial billboard display, the presentation may be adjusted to potentially increase a viewer's awareness of key terms or phrases; in a multi-purpose consumer device, such as a vanity mirror with integral display, the presentation location may be altered to adjust (e.g., minimize, maximize, etc.) the intrusion of the information relative to the user.

Following are descriptions of illustrative embodiments of the present invention that, when taken in conjunction with the drawings will demonstrate the above noted features and advantages, as well as other features and advantages.

The drawings are included for illustrative purposes and are not intended to limit the scope of the invention. In the drawings:

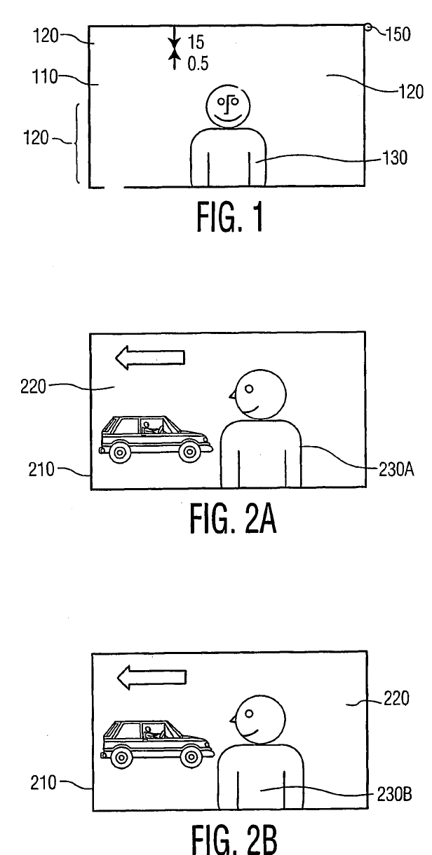

FIG. 1 illustrates an example display of information on a reflective surface based on a location of a user relative to the reflective surface, in accordance with this invention.

FIGS. 2A and 2B illustrate an example dynamic display of information based on different viewer locations relative to the display, in accordance with this invention.

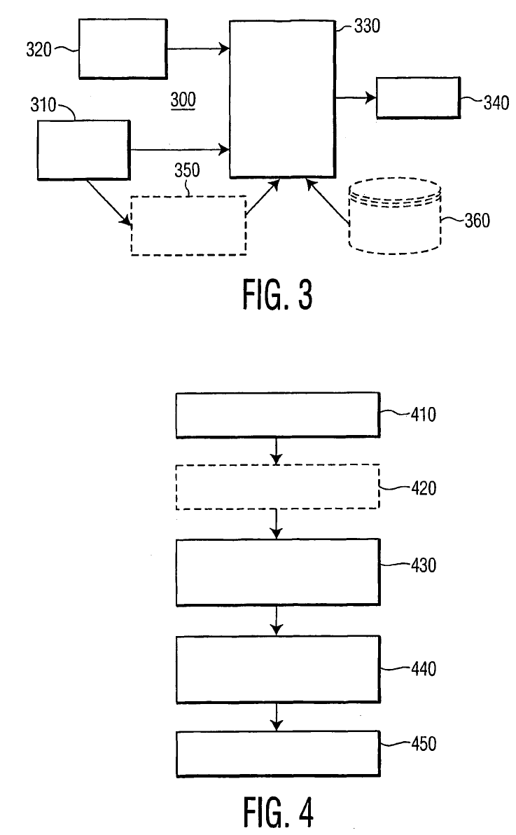

FIG. 3 illustrates an example block diagram of a display system that presents information on a display device based on a viewer's location relative to the display device, in accordance with this invention.

FIG. 4 illustrates an example flow diagram of a method of displaying information based on a viewer's location relative to a display device, in accordance with this invention

Throughout the drawings, the same reference numeral refers to the same element, or an element that performs substantially the same function.

This invention is presented using the paradigm of a messaging system, wherein a display device presents information comprising text, images, audiovisual content, etc. One of ordinary skill in the art will recognize that the principles of this invention are not limited by the type of information being displayed, including, for example, information comprising continuous video streams.

FIG. 1 illustrates an example display of information 120 on a reflective surface 110 based on a position of a user relative to the reflective surface 110. In this example, the user's image 130 is reflected from the surface 110, and the information 120 is displayed on the surface 110 so as not to substantially interfere with the user's image 130. The example information 120 includes a weather forecast to the right of the image 130, a stock market update above and to the left of the image 130, and a shopping list to the left of the image 130. In a one embodiment, to minimize frequent shifting of information, the regions for displaying the information 120 are determined based on an initial stable position of the user, and are not changed until the user assumes a substantially different stable position. Optionally, the user can adjust the parameters used to trigger a rearrangement of the information as the position of the user relative to the surface 110 changes. Also optionally, the user can direct the system to have select information purposely interfere with the user's image 130, such as e-mail messages marked ‘urgent’, significant activity on a particular stock, and so on. As discussed further below, the presentation of the information 120 may be based on a user's profile.

A detector 150 determines a position of the user/viewer relative to the reflective surface 110. Although a single discrete entity is illustrated for the detector 150, the detector 150 may include multiple sensors. For example, the detector 150 may include a matrix of light/color sensors within the display, and the relative position of the user is determined via the detection of a change of light/color levels compared to a reference background set of light/color levels. Alternatively, the detector 150 may include a video or infrared camera, and the position of the user is determined using conventional image-detection techniques. Other position determining means, such as sonar, infrared (IR) sensors, RFID detection, and the like, may also be used. For the purposes of this disclosure, the detector 150 is any device or combination of devices that detects the presence and relative position of a user, and provides information from which a projection 130 corresponding to the user relative to the surface 110 can be determined or estimated. In addition, the detector 150 may identify the user to assist in providing a personalized presentation of information and display location.

In an embodiment of this invention, the presentation of the information 120 on the surface 110 may be based on data contained in a user profile. In such an embodiment, the user profile contains an indication of the type or class of information that the user intends for display as information 120, and/or an indication of the manner and form of the display of the information 120 on the surface 110. For example, the user profile may indicate that the user desires unread e-mail, particular stock-prices, and current grocery-lists to be displayed as the information 120; or, the user profile may indicate that the current grocery-list only be displayed on demand, or the stock-prices displayed only if a particular criteria is met; and so on. In like manner, the user profile may indicate that particular items of the information 120 be displayed more prominently than others, wherein a prominent display is defined as a form or method of display that is easier to visually detect than less-prominent display. Prominence can include both the location and format of the displayed information. For example, urgent e-mail may be displayed in a larger font than less-urgent e-mail; falling stock-prices may be displayed with a flashing border; critical grocery items may be presented using a bold color; news-flashes may be presented at eye-level; and so on. Similarly, the position of the displayed information 120 may be dependent upon rules or guidelines found in the user profile, and may include rules such as: “never block my face while I'm shaving”; “flash an alert at eye-level if I receive an e-mail from X”; “display only the subject line if more than N e-mail messages are received”; display stock information positioned to one side (e.g., left) of the projection 130 and personal organizer information on the other side (e.g., right) of the projection 130; and so on. These and other means of customizing a display of information for a user will be evident to one of ordinary skill in the art in view of this disclosure.

Copending U.S. patent application “MIRROR DISPLAY MESSAGE BOARD”, Ser. No. 10/295,672, filed Nov. 15, 2002, for Gerrit Hollemans, Attorney Docket NL021192, discloses a mirror display message board wherein the displayed information is dependent upon a recognition of the current user of the mirror, and is incorporated by reference herein. In this copending application, the user identifies himself/herself via an input device, such as a touch-sensitive input region of the mirror, or the system includes a recognition system, such as an image recognizer or voice recognizer, that is configured to automatically identify a recognized user when the user is proximate to the mirror. Other means of identifying a user would readily occur to a person of ordinary skill in the art, such as a computer vision system. These and others should be understood to within the scope of relavant pending claims.

In conjunction with the instant invention, the user-identification process of this copending application or other systems can be used to access, for example, a unique user profile for each user of a group of identified potential users of the mirror. Further, a generic user profile may be utilized for unidentified users. In this way, a display of information may be provided that is customized, in form or content, for a user.

In like manner, different profiles may be stored to facilitate the viewer-location-dependent display of information. For example, different profiles may be defined for viewers within different height ranges. When the system detects a viewer, it also detects the viewer's height and selects the predefined profile for displaying information to viewers within the determined height range. In like manner, different profiles may be defined for different numbers of concurrent viewers; one profile, or set of profiles, may be used for single viewers, and a different profile or set of profiles may be used when two or more viewers are detected.

FIGS. 2A and 2B illustrate an example of a dynamic display of information 220 based on the position of different viewers 230A, 230B relative to a display 210. As illustrated, viewer 230A is taller than viewer 230B, and thus is positioned differently than viewer 230B relative to the display 210. In accordance with this invention, the information 220 is presented differently to each of these viewers 230A, 230B, based on their different positions relative to the display 210. In FIG. 2A, the text line, advertising “Car Rental”, is presented at the approximate eye-level of the viewer 230A, and in FIG. 2B, the text line is presented at a lower location on the display 210, corresponding to the approximate eye-level of the viewer 230B. In accordance with the present invention, other modifications to the information display may be effected other than the illustrated simple vertical translation, such as a rearrangement of segments of the information 220, similar to the segmented display of information 120 of FIG. 1. The segmentation of the information 120 for display may be dependent upon the size or form of particular items of information 220, as well as the amount of available unobscured, or obscured, viewing area on the display 210.

In view of this disclosure, one of ordinary skill in the art will recognize that various techniques can be used to display information based on the relative position of one or more viewers. For example, as multiple viewers traverse the display, the display of the information could gradually change based on an average position of the current viewers.

FIG. 3 illustrates an example block diagram of a display system 300 in accordance with this invention. A display processor 330 receives input from a viewer-detector 310, and from an information content-source 320.

The viewer-detector 310 may be any device or system that is configured to enable a determination of a position of a viewer relative to a display device 340, and includes, for example, the above discussed detector 150, which may be an image-detection array, a camera, sonar, RFID detector, computer vision system, etc.

The content source 320 provides information that is to be displayed, and includes, for example, text segments, text and image segments, continuous video segments, or other information types. In an embodiment, the content source 320 may include a network access device, thereby facilitating access to e-mail, news, and other information sources and types. In this or an other embodiment, the content source 320 may be a local or remote storage device.

In accordance with this invention, the display processor 330 presents the information from the content source 320 to a display device 340 dependent upon the input received from the detector 310. In one embodiment of the present invention and depending upon the particular application, the display processor 330 may adjust the presentation of the information from the source 320 so as not to significantly interfere with an image of the viewer, as discussed above with regard to FIG. 1, or the processor 330 may adjust the presentation of the information from the source 320 so as to be purposefully noticeable by the viewer, as discussed above with regard to FIGS. 2A and 2B, or a combination thereof.

Optionally, as discussed above, the display processor 330 may access a database 360 that contains one or more profiles that facilitate the determination of the information content to be displayed, and/or the determination of the format used for displaying the information content. If the display system 300 is configured to provide user-specific content and/or format, a recognition system 350 is provided to facilitate user identification, and the processor 330 is configured to select the appropriate user-profile from the database 360. As would be readily apparent to a person of ordinary skill in the art, the viewer detector 310 may be integrated into the recognition system 350, for example, in a computer vision system. Further, the term database is used herein to define any collection of data that is structured to facilitate retrieval of items from the collection.

FIG. 4 illustrates an example flow diagram of a method of displaying information based on a viewer's location relative to a display device, as may be used, for example, in a computer program that is configured to dynamically control the presentation of information on a mirror display board.

At 410, the position of a user/viewer is detected, relative to the display board. As noted above, any of a variety of techniques may be used to detect the location of the user, including imaging, IR, sonar, and so on. Optionally, the user may be uniquely identified, at 420, using either a manual log-in process or an automated process including, for example, image or voice recognition techniques.

At 430, the information to be displayed is determined. The information may be fairly static, such as advertisements and the like, or it may be dynamic, such as current news items, e-mail, and so on. If the optional user identification process at 420 is included, the information that is to be displayed may be user-specific information, and may be defined in a set of profile data associated with each identifiable user.

At 440, the display format is determined, including identifying the location on the display board that is to be used for presenting the information to the viewer. The viewer's position relative to the display board, as determined in block 410, is used to partition the display board into different user-location-dependent regions, such as non-interfering regions, prominent regions, and so on. As noted above, depending upon the particular application of this invention, the location and format for presenting the information may be chosen so as not to interfere with a reflection of the viewer, it may be chosen so as to occupy a very prominent region relative to the viewer, it may be chosen to be located in particular portions of the display area relative to a reflection of the viewer, or any combination thereof. Further, the location and format for presenting the information may be chosen depending upon the particular items of information being presented. Optionally, the parameters and/or rules for presenting the information may be located in a set of profile data, and different profiles may be provided for different viewers and/or classes of viewers. If the optional user identification process at 420 is included, the display location and format may be user-specific, and defined in the aforementioned set of profile data associated with each identifiable user.

At 450, the information identified at block 430 is displayed, using the location and format determined at block 440, thereby effecting a viewer-location-dependent display of information on the display board.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the invention is presented in the context of adjusting the location of the displayed information, one of ordinary skill in the art will recognize that other parameters of the displayed information may be adjusted based on the relative location of a viewer. If a distant viewer is detected, for example, the text font size may be increased, presenting only the ‘headlines’ of messages; as the viewer approaches the display, the font size is decreased, allowing more information to be presented. In like manner, graphic images may be displayed to initially attract viewers, then additional textual information may be provided when the viewer approaches the display and/or when the viewer decreases his or her velocity while traversing the display. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A display system comprising:
a display processor that is configured to present information from a content source to a display device,
a detector that is configured to detect a position of a viewer relative to the display device,
wherein
the display processor presents the information to the display device based on the position of the viewer relative to the display device.

2. The display system of claim 1, further including
the display device.

3. The display system of claim 1, wherein
the display device is reflective, and
the display processor is configured to present the information so as to substantially avoid displaying the information in an area corresponding to a reflection of the viewer.

4. The display system of claim 1, wherein
the display processor is configured to present the information in a prominent area of the display device relative to the position of the viewer.

5. The display system of claim 1, wherein
the content source includes a network access device.

6. The display system of claim 1, wherein
the detector includes at least one of:
an image detector,
a sound detector,
a camera,
a sonar device, and
an infrared device.

7. The display system of claim 1, wherein
the detector is configured to estimate a projection of an image of a viewer on the display device, based on the position of the viewer.

8. The display system of claim 1, wherein
the display processor is configured to control at least one of the following, based on the position of the viewer:
location of the information on the display device,
size of the information on the display device, and
content of the information on the display device.

9. The display system of claim 1, further including
a recognition system that is configured to provide an identification of the viewer,
wherein
the display processor is further configured to present the information to the display device based on the identification of the viewer.

10. The display system of claim 1, further including
a database that is configured to store one or more profiles,
wherein
the display processor is further configured to present the information to the display device based on a select profile of the one or more profiles.

11. A method of displaying information on a display device, comprising:
determining a position of a viewer relative to the display device, and
displaying the information on the display device based on the position of the viewer.

12. The method of claim 11, wherein
the display device is reflective, and
determining the position of the viewer includes determining an area corresponding to a reflection of the viewer on the display device, and
displaying the information includes positioning the information on the display device so as to substantially avoid the reflection of the viewer.

13. The method of claim 11, wherein
displaying the information includes presenting the information in a prominent area of the display device relative to the position of the viewer.

14. The method of claim 11, further including
obtaining the information from a network.

15. The method of claim 11, wherein
determining the position of the viewer includes at least one of:
detecting an image,
detecting reflected energy, and
detecting heat.

16. The method of claim 11, wherein
displaying the information includes controlling at least one of:
location of the information on the display device,
size of the information on the display device, and
content of the information on the display device.

17. The method of claim 11, further including
determining an identification of the viewer,
wherein
displaying the information is further based on the identification of the viewer.

18. The method of claim 11, further including
selecting a profile from a plurality of profiles,
wherein
displaying the information is further based on the profile.

19. A computer program that, when executed on a processing system, causes the processing system to:
determine a position of a viewer relative to a display device, and
control a display of information on the display device based on the position of the viewer.

20. The computer program of claim 19, wherein the computer program further causes the processing system to:
determine an area on the display device corresponding to a reflection of the viewer on the display device, based on the position of the viewer, and
position the information on the display device so as to substantially avoid the reflection of the viewer.

21. The computer program of claim 19, wherein the computer program further causes the processing system to:
present the information in a prominent area of the display device relative to the position of the viewer.

22. The computer program of claim 19, wherein
the control of the display includes control of at least one of:
location of the information on the display device,
size of the information on the display device, and
content of the information on the display device.

23. The computer program of claim 19, wherein the computer program further causes the processing system to
determine an identification of the viewer, and
control the display of information on the display device based further on the identification of the viewer.
